(19) United States
(12) Patent Application Publication
(10) Pub. No.: US 2026/0138609 A1
(43) Pub. Date: May 21, 2026

(54) APPARATUS FOR OPERATING A BRAKE ASSEMBLY AND VEHICLE

(71) Applicant: Dr. Ing. h.c. F. Porsche Aktiengesellschaft, Stuttgart (DE)

(72) Inventors: Martin STRITTMATTER, Schwieberdingen (DE); Andreas BEBION, Waiblingen (DE); Holger KLEINKNECHT, Benningen a./N. (DE)

(21) Appl. No.: 19/381,034

(22) Filed: Nov. 6, 2025

(30) Foreign Application Priority Data
Nov. 15, 2024 (DE) 10 2024 133 439.8

(51) Int. Cl. B60W 30/18; B60W 10/02; B60W 10/188

(52) U.S. Cl. CPC B60W 30/18109; B60W 10/02; B60W 10/188; B60W 2540/12

(57) ABSTRACT

An apparatus operates an electro-hydraulic brake having a hydraulic unit with electrically actuatable valves controlled via an electrical signal to influence hydraulic pressure at hydraulic brakes. A controller moves a clutch into an open state when a first operating element is actuated from a first end position to a second end position and outputs a first electrical signal to the hydraulic unit to cause a brake slippage to be generated. The controller further moves the clutch to a closed state when the first operating element is actuated from the second end position to the first end position and outputs a second electrical signal to the hydraulic unit to terminate the brake slippage. The controller further does not output the first electrical signal and does not influence the clutch in a second state when the first operating element is actuated from the first end position to the second end position.

### CROSS REFERENCE TO RELATED APPLICATIONS

This application claims benefit to German Patent Application No. DE 102024133 439.8, filed on November 15, 2024, which is hereby incorporated by reference herein.

### FIELD

The present disclosure relates to an apparatus for operating a brake assembly for a rear wheel axle and a vehicle having such an apparatus.

### BACKGROUND

US 2018 / 0251106 A1 shows a method for operating a braking system of a vehicle.

US 2022 / 0080837 A1 shows a vehicle having a braking system.

US 2019 / 0126938 A1 shows a power braking system.

US 2019 / 0256071 A1 shows a system for braking a vehicle.

DE 102017118043 A1 shows a power-based electric parking brake control.

### SUMMARY

In an embodiment, the present disclosure provides an apparatus that operates a brake assembly of a vehicle. The apparatus includes: a rear wheel axle; a clutch assembly; the brake assembly; a first operating element; and a controller. The clutch assembly is configured to: connect the rear wheel axle to a powertrain in a closed state; and disconnect the rear wheel axle from the powertrain in an open state. The brake assembly is an electro-hydraulic brake assembly that includes a hydraulic pump, a hydraulic unit and two hydraulic brakes for the rear wheel axle. The hydraulic pump is configured to generate a hydraulic pressure. The hydraulic unit includes electrically actuatable valves, which are configured to be controlled via an electrical signal, and is configured to influence the hydraulic pressure at the hydraulic brakes via the valves as a function of the electrical signal. The first operating element is configured to be operated with one hand and is configured to be moved back and forth between a first end position and a second end position. The controller has a first state and a second state. The controller is configured to: move the clutch into the open state in the first state when the first operating element is actuated from the first end position to the second end position; and output a first electrical signal to the hydraulic unit and thereby cause a brake slippage to be generated on the rear wheel axle. The controller is further configured to: move the clutch to the closed state in the first state when the first operating element is actuated from the second end position to the first end position; and to output a second electrical signal to the hydraulic unit and as a result terminate the brake slippage generated at the rear wheel axle. The controller is further configured not to output the first electrical signal and not to influence the clutch in the second state when the first operating element is actuated from the first end position to the second end position.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 provides, in a schematic illustration, a vehicle having a rear wheel axle; and

FIG. 2 shows an operating element.

### DETAILED DESCRIPTION

Aspects of the present disclosure provide a new apparatus for operating a brake assembly and a new vehicle.

An aspect of the present disclosure provides an apparatus for operating a brake assembly of a vehicle, comprising a rear wheel axle, a clutch assembly, a brake assembly, a first operating element and a control device, wherein the clutch assembly is configured to connect the rear wheel axle to a powertrain in a closed state and disconnect it from the powertrain in an open state, wherein the brake assembly as an electro-hydraulic brake assembly has a hydraulic pump, a hydraulic unit and two hydraulic brakes for the rear wheel axle, wherein the hydraulic pump is configured to generate a hydraulic pressure, wherein the hydraulic unit comprises electrically actuatable valves, which can be controlled via an electrical signal and is configured to influence the hydraulic pressure at the hydraulic brakes generated by the hydraulic pump via the valves as a function of the electrical signal, wherein the first operating element can be operated with one hand (manual) and can be moved back and forth between a first end position and a second end position, wherein the control device has a first state and a second state, wherein the control device is configured to: move the clutch into the open state in the first state when the first operating element is actuated from the first end position to the second end position; output a first electrical signal to the hydraulic unit and as a result cause a brake slippage to be generated on the rear wheel axle, wherein the control device is configured to move the clutch to the closed state in the first state when the first operating element is actuated from the second end position to the first end position, and to output a second electrical signal to the hydraulic unit and as a result terminate the brake slippage generated at the rear wheel axle, wherein the control device is configured not to output the first electrical signal and not to influence the clutch in the second state when the first operating element is actuated from the first end position to the second end position.

Particularly in extreme driving situations, such as during a rally, the control device together with such a first operating element allows good control of the vehicle. Disabling this feature in the second state increases safety in normal traffic.

According to a preferred aspect of the present disclosure, the first operating element comprises a lever having a dampening element for dampening the lever movement. The dampening element provides resistance during operation, and a lever allows for precise control of the feature.

According to a preferred aspect of the present disclosure, the first operating element is arranged between the two front seats. An arrangement without a large distance between the steering wheel and the first operating element allows ergonomically advantageous operation by the driver.

According to a preferred aspect of the present disclosure, the first operating element has a sensor for sensing the position. This allows position information to be generated as well as operating speed information (taking into account the time) for further processing in the control device.

According to a preferred aspect of the present disclosure, the sensor is configured to send data in accordance with the Society of Automotive Engineers (SAE) standard SAE J2716 (SENT protocol). This increases the security of the data transfer and thus the entire system.

According to a preferred aspect of the present disclosure, the control device is also configured also to sense intermediate positions of the first operating element between the first end position and the second end position. This allows a reaction to the intermediate positions.

According to a preferred aspect of the present disclosure, the control device is configured to adjust different hydraulic pressures via a third signal as a function of different intermediate positions of the first operating element. A further influencing variable may represent the operating speed of the first operating element. This allows the driver to achieve different braking effects by adjusting the intermediate positions. This leads to different brake slippages of the rear wheels.

According to a preferred aspect of the present disclosure, the control device is configured in the first state to smoothly move the clutch to the closed state when the first operating element is actuated from the second end position to the first end position. The maximum forces occurring in the powertrain are thereby reduced. The smooth engagement ensures that the driver is able to transition from two driving states in a homogeneous and simpler manner. In this case, reference is made to the braked or load-free accelerating state.

According to a preferred aspect of the present disclosure, the apparatus comprises a second operating element and a third operating element, wherein the control device is configured to require actuation of the second operating element and the third operating element to activate the first state. This ensures that the vehicle does not switch on accidentally if the first operating element is accidentally activated when starting the vehicle. Further, this generally reduces the risk of accidental switch-on. However, for a pure rally vehicle, it is also possible to enable activation of the first state directly when the vehicle is started.

According to a preferred aspect of the present disclosure, the second operating element and the third operating element are arranged on an instrument panel or on a steering wheel. The first or second states can thereby be adjusted from the driver’s seat.

According to a preferred aspect of the present disclosure, the apparatus comprises a brake pedal, wherein the control device is configured to enable braking via the brake pedal in both the first state and the second state. As a result, the driver always has access to braking via the brake pedal.

According to a preferred aspect of the present disclosure, the apparatus comprises a brake booster, wherein the brake booster is configured to boost a hydraulic pressure and can be influenced by both the brake pedal and the control device, and wherein the brake booster is configured to deliver the generated hydraulic pressure to the hydraulic unit, thereby allowing the hydraulic brakes to be influenced. This enables the braking process to be advantageously influenced by the brake pedal.

According to a preferred aspect of the present disclosure, the apparatus comprises an output element, wherein the output element outputs first optical information when the control device is in the first state. This allows the driver to be reliably informed of the presence of the functionality.

According to a preferred aspect of the present disclosure, the output element outputs second optical information when the first operating element is operated in the first state, wherein the second optical information is different from the first optical information. This increases safety, as the driver receives feedback about the active feature.

A vehicle comprises such a device. Such a vehicle may be particularly advantageously controlled in extreme situations.

Further details and advantageous further developments of aspects of the present disclosure will emerge from the embodiment examples, which are described below and illustrated in the drawings and are not to be construed as limiting the disclosure in any way. It goes without saying that the features mentioned above and those yet to be discussed below can be used not only in the respectively specified combination, but also in other combinations or on their own, without leaving the scope of the present disclosure.

Parts that are the same or have the same effect are provided with the same reference numbers in the following and are usually described only once. The descriptions of all of the figures build on one another in order to avoid unnecessary repetitions.

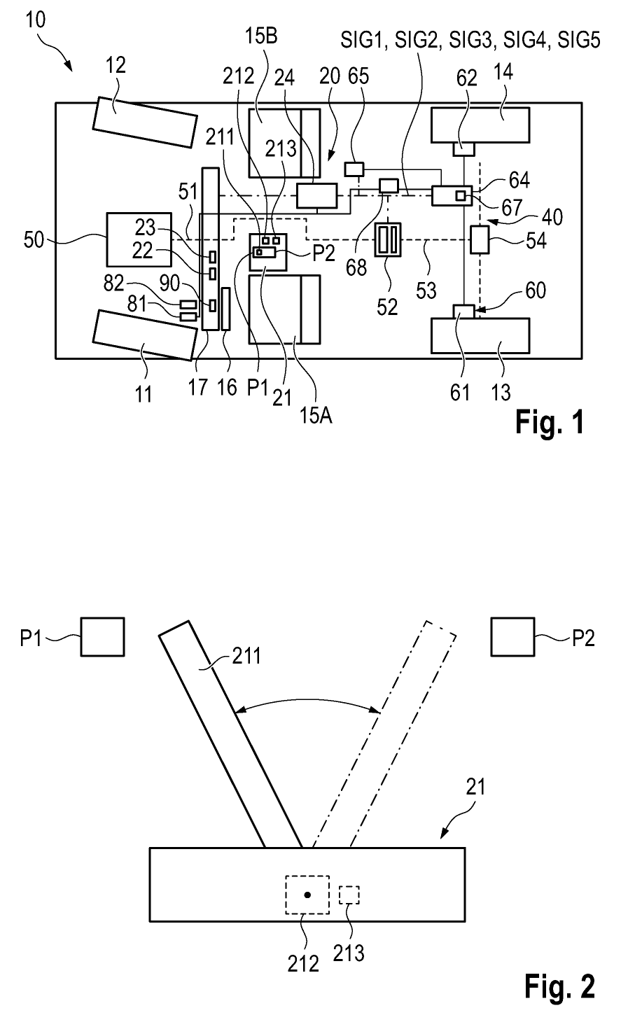

FIG. 1 shows a vehicle 10. The vehicle 10 has a drive 50, for example an internal combustion engine, an electric motor, or a hybrid drive. The drive 50 together with a torque transfer device forms a powertrain 51.

The vehicle 10 has two front wheels 11, 12 and two rear wheels 13, 14, a front seat 15A for a driver, and a schematically indicated front seat 15B for a passenger, a steering wheel 16, an instrument panel (console) 17, a brake pedal 81, an accelerator pedal 82, and an apparatus 20 for operating a brake assembly 60.

The apparatus 20 has the rear wheel axle 40, a clutch assembly 52, a brake assembly 60, a first operating element 21, and a control device (also referred to herein as a controller) 24.

The clutch assembly 52 is configured to connect the rear wheel axle 40 to the powertrain 51 in a closed state and to disconnect it from the powertrain 51 in an open state.

The brake assembly 60 is configured as an electro-hydraulic brake assembly and comprises a hydraulic pump 65, a hydraulic unit 64, and two hydraulic brakes 61, 62 for rear wheel axle 40. Preferably, hydraulic brakes are also provided on the front wheels 11, 12.

The hydraulic unit 64 has electrically actuatable valves 67. The valves 67 are actuatable via an electrical signal SIG1, SIG2, SIG3 and are configured to influence the hydraulic pressure on the hydraulic brakes 61, 62 via the valves 67 as a function of the electrical signal SIG1, SIG2, SIG3. To this end, the electrical signals SIG1, SIG2, SIG3 each carry desired information. Preferably, the hydraulic unit 64 has at least one electrically actuatable valve 67 for each of the hydraulic brakes 61, 62 in order to enable individual control of the brakes 61, 62.

The first operating element 21 can be operated with one hand and moves back and forth between a first end position P1 and a second end position P2.

Preferably, the first operating element 21 is arranged between the front seats. The assembly is ergonomically arranged with a short distance between the driver’s seat 15A and the steering wheel 16. Here, for example, it may be arranged directly adjacent to the driver’s seat 15A or partially or completely further forward.

The control device 24 comprises a first state S1 and a second state S2.

The control device 24 is configured to move the clutch 52 to the open state in the first state S1 when the first operating element 21 is actuated from the first end position P1 to the second end position P2 and to output a first electrical signal SIG1 to the hydraulic unit 64.

Preferably, a fourth electrical signal SIG4 is also output to the hydraulic pump 65 to activate it or increase pumping power.

Preferably, a fifth electrical signal SIG5 is also output to the brake booster 68 to activate it or increase its boost.

By these actions, a brake slippage is generated on the rear wheel axle 40.

The brake pressure build-up for generating brake slippage on the rear wheel axle 40 is preferably initially carried out via the brake booster 68; the hydraulic pump 65 is used in parallel with the supportive pressure build-up and for the control pressure generation.

The brake booster 68 is preferably an electrical brake booster and as a result allows for a fast brake pressure build-up.

The hydraulic pump is typically slower than the brake booster and is particularly used for control pressure generation.

The brake booster 68 makes it possible to increase both the foot operating force when the brake pedal 81 is pressed and the associated hydraulic brake pressure build-up and to build up hydraulic brake pressure independently of the brake pedal operation via electronic control by the control device 24.

This is advantageous, for example, in a rally car 10, and it enables strong braking of the rear wheels 13, 14 and, due to the resulting slippage, drifting of the vehicle 10 in order to increase the rotation around the vertical axis of the vehicle 10. For example, when making a hairpin turn and a corresponding racing line, the rear of vehicle 10 can slide sideways around the hairpin turn by pulling the first operating element 21 to the second end position, thereby allowing the hairpin turn to be driven around quickly. Moving the clutch 52 to the open state reduces the forces acting on the powertrain 51, thereby reducing torsion.

The control device 24 is configured to move the clutch 52 to the closed state in the first state S1 when the first operating element 21 is actuated from the second end position P2 to the first end position P1 and to output a second electrical signal SIG2 to the hydraulic unit 64, thereby terminating the specific braking of the rear wheel axle 40.

This allows vehicle 10 to be driven again, for example after drifting around a curve.

Preferably, the control device 24 is configured to smoothly move the clutch 52 to the closed state when the first operating element 21 is actuated from the second end position P2 to the first end position P1 in the first state S1. As a result, both the forces in the powertrain are reduced and the controllability for the driver is improved.

The control device 24 is configured not to output the first electrical signal SIG1 and not to influence the clutch 52 in the second state S2 when the first operating element 21 is actuated from the first end position P1 to the second end position P2.

The control device 24 and the operating element are preferably also configured to sense intermediate positions of the first operating element 21 between the first end position P1 and the second end position P2 as well as preferably the operating speed. This allows for different slippage states and slippage build-up speeds.

Preferably, the control device 24 is configured to adjust different hydraulic pressures via a third signal SIG3 as a function of different intermediate positions of the first operating element 21. The braking effect can thereby be adjusted more precisely by the driver.

Preferably, the apparatus 20 comprises the second operating element 22 and the third operating element 23. The control device 24 is preferably configured to require actuation of the second operating element 22 and the third operating element 23 to activate the first state S1. This reduces the risk of the first state S1 being accidentally selected.

Preferably, the second operating element 22 and the third operating element 23 are arranged on the instrument panel 17 or on the steering wheel 16 and are thereby easily operable.

Preferably, the control device 24 is configured to enable braking via the brake pedal 81 in both the first state S1 and the second state S2. This gives the driver full control over the braking behavior with their foot in both states.

Preferably, the apparatus 20 comprises a brake booster 68, wherein the brake booster 68 is configured to boost a hydraulic pressure and can be influenced by both the brake pedal 81 and the control device 24, and wherein the brake booster 68 is configured to deliver the generated hydraulic pressure to the hydraulic unit 64, thereby allowing the hydraulic brakes 62 to be influenced.

Preferably, the apparatus 20 comprises an output element 90, wherein the output element 90 outputs optical information when the control device 24 is in the first state S1. This clearly informs the driver that actuation of operating element 21 has an effect on the braking behavior.

FIG. 2 shows the first operating element 21. This has a lever 211 with a dampening element (also referred to herein as a dampener) 212 for dampening the lever movement.

The first operating element 21 comprises a sensor 213.

The sensor 213 is preferably configured to send data in accordance with the SAE standard SAE J2716 (SENT protocol). This increases security.

Many variants and modifications are of course possible within the scope of the present disclosure.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An apparatus, the apparatus comprising:
a rear wheel axle;
a clutch ;
a brake assembly;
a first operating element; and
a controller,
wherein the clutch is configured to:
connect the rear wheel axle to a powertrain in a closed state; and
disconnect the rear wheel axle from the powertrain in an open state,
wherein the brake assembly is an electro-hydraulic brake assembly that comprises a hydraulic pump, a hydraulic unit and two hydraulic brakes for the rear wheel axle,
wherein the hydraulic pump is configured to generate a hydraulic pressure,
wherein the hydraulic unit comprises electrically actuatable valves, which are configured to be controlled via an electrical signal and is configured to influence the hydraulic pressure at the hydraulic brakes via the valves as a function of the electrical signal,
wherein the first operating element is configured to be operated with one hand and is configured to be moved back and forth between a first end position and a second end position,
wherein the controller comprises a first state and a second state,
wherein the controller is configured to: move the clutch into the open state in the first state when the first operating element is actuated from the first end position to the second end position; and output a first electrical signal to the hydraulic unit and thereby cause a brake slippage to be generated on the rear wheel axle,
wherein the controller is further configured to: move the clutch to the closed state in the first state when the first operating element is actuated from the second end position to the first end position; and to output a second electrical signal to the hydraulic unit and as a result terminate the brake slippage generated at the rear wheel axle, and
wherein the controller is further configured not to output the first electrical signal and not to influence the clutch in the second state when the first operating element is actuated from the first end position to the second end position.

2. The apparatus according to claim 1, wherein the first operating element comprises a lever with a dampener that is configured to dampen movement of the lever.

3. The apparatus according to claim 1, wherein the first operating element is arranged between front seats of a vehicle comprising the brake assembly.

4. The apparatus according to claim 1, wherein the first operating element comprises a sensor.

5. The apparatus according to claim 1, wherein the controller is further configured to sense intermediate positions of the first operating element between the first end position and the second end position.

6. The apparatus according to claim 5, wherein the controller is further configured to adjust different hydraulic pressures via a third signal and thereby different brake slippages and their build-up speed as a function of different intermediate positions and operating speeds of the first operating element.

7. The apparatus according to claim 1, wherein the controller is further configured to smoothly move the clutch to the closed state in the first state when the first operating element is actuated from the second end position to the first end position.

8. The apparatus according to claim 1, the apparatus further comprising a second operating element and a third operating element, wherein the controller is configured to require actuation of the second operating element and the third operating element to activate the first state.

9. The apparatus according to claim 8, wherein the second operating element and the third operating element are arranged on an instrument panel or on a steering wheel.

10. The apparatus according to claim 1, the apparatus further comprising a brake pedal, wherein the controller is configured to enable braking via the brake pedal in both the first state and the second state.

11. The apparatus according to claim 1, the apparatus further comprising a brake pedal and a brake booster, wherein the brake booster is configured to boost a hydraulic pressure and is configured to be influenced by both the brake pedal and the controller, and wherein the brake booster is configured to deliver the generated hydraulic pressure to the hydraulic unit, thereby allowing the hydraulic brakes to be influenced.

12. The apparatus according to claim 11, wherein the controller is further configured to generate the brake pressure build-up for generating brake slippage on the rear wheel axle at least temporarily via both the brake booster and the hydraulic pump, wherein the brake pressure build-up is configured to be initially carried out via the brake booster.

13. The apparatus according to claim 1, wherein the controller is further configured to output a fourth signal to the hydraulic unit in the first state when the first operating element is actuated from the first end position to the second end position.

14. The apparatus according to claim 1, further comprising an output element, wherein the output element is configured to output first optical information when the controller is in the first state.

15. The apparatus according to claim 14, wherein the output element is configured to output second optical information when the first operating element is operated in the first state, wherein the second optical information is different from the first optical information.

16. A vehicle comprising the apparatus according to claim 1.

17. The apparatus according to claim 4, wherein the sensor is configured to send data according to a SENT protocol.
